(19) United States
(12) Patent Application Publication
(10) Pub. No.: US 2021/0103852 A1
(43) Pub. Date: Apr. 8, 2021

(54) RESOURCE BASED WORKLOAD ALLOCATION FOR MACHINE LEARNING WORKLOADS

(71) Applicant: QUALCOMM Incorporated, San Diego, CA (US)

(72) Inventors: Elina Kamenetskaya, Belmont, MA (US); Andrew Evan Gruber, Arlington, MA (US); Amir Momeni, Boston, MA (US)

(21) Appl. No.: 16/591,353

(22) Filed: Oct. 2, 2019

(51) Int. Cl. G06N 20/00; G06T 15/00; G06F 9/50

(52) U.S. Cl. CPC G06N 20/00; G06F 9/505; G06T 15/005

(57) ABSTRACT

Methods, systems, and devices for workload balancing for machine learning are described. Generally, a device may determine a size of a level one cache of a texture processor, identify a portion of input activation data for an iterative machine-learning process, and load the portion of input activation data into the level one cache. The device may allocate, based at least in part on a texture processor to shading processor arithmetic logic unit (ALU) resource ratio, a first set of one or more weight batches and a second set of one or more weight batches associated with the loaded portion of input activation data to the shading processor, and process the portion of input activation data based at least in part on the first set of one or more weight batches and the second set of one or more weight batches using the texture processor and the shading processor in parallel.

### BACKGROUND

The following relates generally to machine learning, and more specifically to resource based workload allocation for machine learning workloads.

A device that provides content for visual presentation on an electronic display may include a processor. One type of processor is a graphic processing unit (GPU). The processor in conjunction with other components renders pixels that are representative of the content on the display. That is, the processor generates one or more pixel values for each pixel on the display and performs graphics processing on the pixel values for each pixel on the display to render each pixel for presentation. For example, the processor may convert two-dimensional or three-dimensional virtual objects into a two-dimensional pixel representation that may be displayed. Converting information about three-dimensional objects into information that can be displayed may require considerable memory and processing power. In a machine learning work load executed by a GPU, process flows and work load balancing may be inefficient, slow, or both.

### SUMMARY

The described techniques relate to improved methods, systems, devices, and apparatuses that support resource based workload allocation for machine learning workloads. Generally, a device may allocate, based at least in part on a texture processor to shading processor arithmetic logic unit (ALU) resource ratio, a first set of one or more weight batches associated with a portion of input activation data to the texture processor and a second set of one or more weight batches associated with the loaded portion of input activation data to the shading processor. The device may process the portion of input activation data based at least in part on the first set of one or more weight batches and the second set of one or more weight batches using the texture processor and the shading processor in parallel.

A method of workload balancing for machine learning is described. The method may include allocating, based on a texture processor to shading processor arithmetic logic unit (ALU) resource ratio, a first set of one or more weight batches associated with a portion of input activation data to the texture processor and a second set of one or more weight batches associated with the portion of input activation data to the shading processor and processing the portion of input activation data based on the first set of one or more weight batches and the second set of one or more weight batches using the texture processor and the shading processor in parallel.

An apparatus for workload balancing for machine learning is described. The apparatus may include a processor, memory coupled with the processor, and instructions stored in the memory. The instructions may be executable by the processor to cause the apparatus to allocate, based on a texture processor to shading processor arithmetic logic unit (ALU) resource ratio, a first set of one or more weight batches associated with a portion of input activation data to the texture processor and a second set of one or more weight batches associated with the portion of input activation data to the shading processor and process the portion of input activation data based on the first set of one or more weight batches and the second set of one or more weight batches using the texture processor and the shading processor in parallel.

Another apparatus for workload balancing for machine learning is described. The apparatus may include means for allocating, based on a texture processor to shading processor arithmetic logic unit (ALU) resource ratio, a first set of one or more weight batches associated with a portion of input activation data to the texture processor and a second set of one or more weight batches associated with the portion of input activation data to the shading processor and processing the portion of input activation data based on the first set of one or more weight batches and the second set of one or more weight batches using the texture processor and the shading processor in parallel.

A non-transitory computer-readable medium storing code for workload balancing for machine learning is described. The code may include instructions executable by a processor to allocate, based on a texture processor to shading processor arithmetic logic unit (ALU) resource ratio, a first set of one or more weight batches associated with a portion of input activation data to the texture processor and a second set of one or more weight batches associated with the portion of input activation data to the shading processor and process the portion of input activation data based on the first set of one or more weight batches and the second set of one or more weight batches using the texture processor and the shading processor in parallel.

Some examples of the method, apparatuses, and non-transitory computer-readable medium described herein may further include operations, features, means, or instructions for identifying, based on a size of a level one cache of the texture processor, the portion of input activation data for an iterative machine-learning process, and loading the portion of input activation data into the level one cache of the texture processor based on the identifying.

In some examples of the method, apparatuses, and non-transitory computer-readable medium described herein, processing the portion of input activation data further may include operations, features, means, or instructions for performing one or more filtering operations on the portion of input activation data, using the first set of one or more weight batches and the second set of one or more weight batches.

In some examples of the method, apparatuses, and non-transitory computer-readable medium described herein, each of the one or more filtering operations further includes a multiply-accumulate operation, where a multiplication aspect of the multiply-accumulate operation includes multiplying a first batch of the first set of one or more weight batches or the second set of one or more weight batches with the portion of input activation data.

Some examples of the method, apparatuses, and non-transitory computer-readable medium described herein may further include operations, features, means, or instructions for determining a number of available ALU resources for the texture processor, determining a number of available ALU resources for the shading processor, determining a total number of available ALU resources including the number of available ALU resources for the texture processor and the number of available ALU resources for the shading processor, and identifying the texture processor to shading processor ALU resource ratio based on the number of available ALU resources for the texture processor and the number of available ALU resources for the shading processor.

Some examples of the method, apparatuses, and non-transitory computer-readable medium described herein may further include operations, features, means, or instructions for identifying an accumulation register space available within the shading processor, where determining the total number of available ALU resources may be based on the accumulation register space.

Some examples of the method, apparatuses, and non-transitory computer-readable medium described herein may further include operations, features, means, or instructions for determining a level two weight batch caching constraint for a second level of an iterative machine-learning process, where determining the total number of available ALU resources may be based on the level two weight batch caching constraint.

Some examples of the method, apparatuses, and non-transitory computer-readable medium described herein may further include operations, features, means, or instructions for generating a portion of output activation data based on the processing the portion of input activation data, and identifying, based on having generated the portion of output activation data and based on the size of a level one cache of the texture processor, a second portion of input activation data for an iterative machine-learning process.

Some examples of the method, apparatuses, and non-transitory computer-readable medium described herein may further include operations, features, means, or instructions for performing one or more iterations of the iterative machine-learning process until all of the input activation data may have been processed.

Some examples of the method, apparatuses, and non-transitory computer-readable medium described herein may further include operations, features, means, or instructions for identifying, by the texture processor, the first set of one or more weight batches from a system memory, and identifying, by the shading processor, the second set of one or more weight batches from the system memory.

Some examples of the method, apparatuses, and non-transitory computer-readable medium described herein may further include operations, features, means, or instructions for identifying, by the texture processor, the first set of one or more weight batches and the second set of one or more weight batches from a system memory, and sending, by the texture processor, the second set of one or more weight batches to the shading processor.

Some examples of the method, apparatuses, and non-transitory computer-readable medium described herein may further include operations, features, means, or instructions for determining a number of fibers associated with a first iteration of an iterative machine-learning process, where identifying the portion of input activation data for the iterative machine-learning process may be based on the number of fibers.

### BRIEF DESCRIPTION OF THE DRAWINGS

FIG. 1 illustrates an example of a system for workload balancing for machine learning that supports resource based workload allocation for machine learning workloads in accordance with aspects of the present disclosure.

FIG. 2 illustrates an example of a filtering process that supports resource based workload allocation for machine learning workloads in accordance with aspects of the present disclosure.

FIG. 3 illustrates an example of a filtering process that supports resource based workload allocation for machine learning workloads in accordance with aspects of the present disclosure.

FIGS. 4 and 5 show block diagrams of devices that support resource based workload allocation for machine learning workloads in accordance with aspects of the present disclosure.

FIG. 6 shows a block diagram of a GPU that supports resource based workload allocation for machine learning workloads in accordance with aspects of the present disclosure.

FIG. 7 shows a diagram of a system including a device that supports resource based workload allocation for machine learning workloads in accordance with aspects of the present disclosure.

FIGS. 8 and 9 show flowcharts illustrating methods that support resource based workload allocation for machine learning workloads in accordance with aspects of the present disclosure.

### DETAILED DESCRIPTION

In a machine learning work load executed by a graphic processing unit (GPU), tasks are divided between the arithmetic and logic units (ALUs) of multiple processors (e.g., a shader processor (SP) and a texture processor (TP)). Performance of the GPU may be bound by data loading and ALU availability and utilization. Improved process flows may decrease data fetching and increase ALU utilization. Such processes may be faster, more efficient, and may improve user experience.

A GPU performing machine learning workload balancing may load input activation data in a level 1 (L1) cache of the texture processor of the GPU, and may synchronize data loading between the shading processor and the texture processor using the level 1 cache. The GPU may partition weight batches corresponding to the cached input activation data between the shading processor and the texture processor. The weight batch allocation may take into account the ratio of available ALUs between the texture processor and the shading processor. The GPU may perform filtering on the input activation data using the allocated weight batches. The GPU may load new input activation data into a level one cache (e.g., a level one cache of the texture processor when both the texture processor and the shading processor have completed filtering the previous input activation data using their allocated weight batches. The GPU may determine the size of the input activation data loaded into the level 1 cache for each loop iteration of the processing procedure and the total number of weight batches used per loop iteration based on the size of the level one cache, a number of fibers associated with each sub-group, accumulation register space available inside the shading processor, and any level two weight batch caching constraints.

Aspects of the disclosure are initially described in the context of a GPU. Aspects of the disclosure are further illustrated by and described with reference to filtering processes, apparatus diagrams, system diagrams, and flowcharts that relate to resource based workload allocation for machine learning workloads.

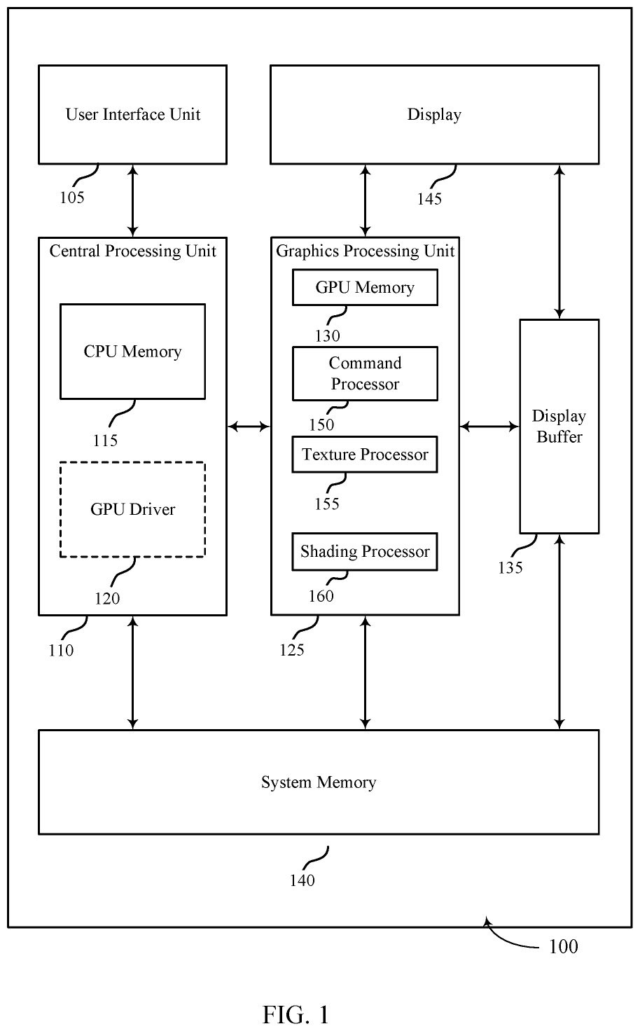

FIG. 1 illustrates an example of a device 100 that supports that supports resource based workload allocation for machine learning workloads in accordance with aspects of the present disclosure. Examples of device 100 include, but are not limited to, wireless devices, mobile or cellular telephones, including smartphones, personal digital assistants (PDAs), video gaming consoles that include video displays, mobile video gaming devices, mobile video conferencing units, laptop computers, desktop computers, televisions set-top boxes, tablet computing devices, e-book readers, fixed or mobile media players, and the like.

In the example of FIG. 1, device 100 includes a central processing unit (CPU) 110 having CPU memory 115, a GPU 125 having GPU memory 130 and command processor 150, a display 145, a display buffer 135 storing data associated with rendering, a user interface unit 105, a system memory 140, a texture processor 155, and a shading processor 160. For example, system memory 140 may store a GPU driver 120 (illustrated as being contained within CPU 110 as described below) having a compiler, a GPU program, a locally-compiled GPU program, and the like. User interface unit 105, CPU 110, GPU 125, system memory 140, and display 145 may communicate with each other (e.g., using a system bus).

Examples of CPU 110 include, but are not limited to, a digital signal processor (DSP), general purpose microprocessor, application specific integrated circuit (ASIC), field programmable logic array (FPGA), or other equivalent integrated or discrete logic circuitry. Although CPU 110 and GPU 125 are illustrated as separate units in the example of FIG. 1, in some examples, CPU 110 and GPU 125 may be integrated into a single unit. CPU 110 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 145. As illustrated, CPU 110 may include CPU memory 115. For example, CPU memory 115 may represent on-chip storage or memory used in executing machine or object code. CPU memory 115 may include one or more volatile or non-volatile memories or storage devices, such as flash memory, a magnetic data media, an optical storage media, etc. CPU 110 may be able to read values from or write values to CPU memory 115 more quickly than reading values from or writing values to system memory 140, which may be accessed, e.g., over a system bus.

GPU 125 may represent one or more dedicated processors for performing graphical operations. That is, for example, GPU 125 may be a dedicated hardware unit having fixed function and programmable components for rendering graphics and executing GPU applications. GPU 125 may also include a DSP, a general purpose microprocessor, an ASIC, an FPGA, or other equivalent integrated or discrete logic circuitry. GPU 125 may be built with a highly-parallel structure that provides more efficient processing of complex graphic-related operations than CPU 110. For example, GPU 125 may include a plurality of processing elements that are configured to operate on multiple vertices or pixels in a parallel manner. The highly parallel nature of GPU 125 may allow GPU 125 to generate graphic images (e.g., graphical user interfaces and two-dimensional or three-dimensional graphics scenes) for display 145 more quickly than CPU 110.

GPU 125 may, in some instances, be integrated into a motherboard of device 100. In other instances, GPU 125 may be present on a graphics card that is installed in a port in the motherboard of device 100 or may be otherwise incorporated within a peripheral device configured to interoperate with device 100. As illustrated, GPU 125 may include GPU memory 130, command processor 150, texture processor 155, and shading processor 160. In one example, GPU memory 130 may represent on-chip storage or memory used in executing machine or object code. GPU memory 130 may include one or more volatile or non-volatile memories or storage devices, such as flash memory, a magnetic data media, an optical storage media, etc. GPU 125 may be able to read values from or write values to GPU memory 130 more quickly than reading values from or writing values to system memory 140, which may be accessed, e.g., over a system bus. That is, GPU 125 may read data from and write data to GPU memory 130 without using the system bus to access off-chip memory. This operation may allow GPU 125 to operate in a more efficient manner by reducing the need for GPU 125 to read and write data via the system bus, which may experience heavy bus traffic.

In some examples, command processor 150 may be a first interface between the GPU 125 and a component external to GPU 125. In some cases, command processor 150 may be configured to perform command and stream fetching, state control, and/or register management. In some examples, command processor 150 may include separate queues for commands, streams, and/or kernels. In some cases, command processor 150 may include direct memory access (DMA) for streams and interrupt control unit. In one example, command processor 150 may be configured to send interrupts to a host of GPU 125 (e.g., device 100).

In some examples, texture processor 155 of GPU 125 may have a level one cache for loading activation input data. Texture processor 155 may be used for fetching and loading input activation data for further processing. Texture processor 155 may store a section of input activation data while ALUs from texture processor 155 and shading processor 160 perform filtering operations on the section in input data. Texture processor 155 may receive weight batch allocations from system memory (e.g., GPU memory 130). In some examples, texture processor 155 may receive weight batch allocations for shading processor 160, and may send the received weight batch allocation to shading processor 160. Texture processor 155 may be collocated with shading processor 160, and both may be part of a texture processing cluster.

In some examples, shading processor 160 may also have one or more ALUs available for performing filtering operations. In some examples, shading processor 160 may receive an allocation of weight batches for performing filtering operations from system memory (e.g., GPU memory 130) or may receive allocations of weight batches directly from texture processor 155.

Display 145 represents a unit capable of displaying video, images, text or any other type of data for consumption by a viewer. Display 145 may include a liquid-crystal display (LCD), a light emitting diode (LED) display, an organic LED (OLED), an active-matrix OLED (AMOLED), or the like. Display buffer 135 represents a memory or storage device dedicated to storing data for presentation of imagery, such as computer-generated graphics, still images, video frames, or the like for display 145. Display buffer 135 may represent a two-dimensional buffer that includes a plurality of storage locations. The number of storage locations within display buffer 135 may, in some cases, generally correspond to the number of pixels to be displayed on display 145. For example, if display 145 is configured to include 640×480 pixels, display buffer 135 may include 640×480 storage locations storing pixel color and intensity information, such as red, green, and blue pixel values, or other color values. Display buffer 135 may store the final pixel values for each of the pixels processed by GPU 125. Display 145 may retrieve the final pixel values from display buffer 135 and display the final image based on the pixel values stored in display buffer 135.

User interface unit 105 represents a unit with which a user may interact with or otherwise interface to communicate with other units of device 100, such as CPU 110. Examples of user interface unit 105 include, but are not limited to, a trackball, a mouse, a keyboard, and other types of input devices. User interface unit 105 may also be, or include, a touch screen and the touch screen may be incorporated as part of display 145.

System memory 140 may comprise one or more computer-readable storage media. Examples of system memory 140 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 140 may store program modules and/or instructions that are accessible for execution by CPU 110. Additionally, system memory 140 may store user applications and application surface data associated with the applications. System memory 140 may in some cases store information for use by and/or information generated by other components of device 100. For example, system memory 140 may act as a device memory for GPU 125 and may store data to be operated on by GPU 125 (e.g., in a direct rendering operation) as well as data resulting from operations performed by GPU 125.

In some examples, system memory 140 may include instructions that cause CPU 110 or GPU 125 to perform the functions ascribed to CPU 110 or GPU 125 in aspects of the present disclosure. System memory 140 may, in some examples, be considered as a non-transitory storage medium. The term “non-transitory” should not be interpreted to mean that system memory 140 is non-movable. As one example, system memory 140 may be removed from device 100 and moved to another device. As another example, a system memory substantially similar to system memory 140 may be inserted into device 100. In certain examples, a non-transitory storage medium may store data that can, over time, change (e.g., in RAM).

System memory 140 may store a GPU driver 120 and compiler, a GPU program, and a locally-compiled GPU program. The GPU driver 120 may represent a computer program or executable code that provides an interface to access GPU 125. CPU 110 may execute the GPU driver 120 or portions thereof to interface with GPU 125 and, for this reason, GPU driver 120 is shown in the example of FIG. 1 within CPU 110. GPU driver 120 may be accessible to programs or other executables executed by CPU 110, including the GPU program stored in system memory 140. Thus, when one of the software applications executing on CPU 110 requires graphics processing, CPU 110 may provide graphics commands and graphics data to GPU 125 for rendering to display 145 (e.g., via GPU driver 120).

The GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API may include a determined, standardized set of commands that are executed by associated hardware. API commands may allow a user to instruct hardware components of a GPU 125 to execute commands without user knowledge as to the specifics of the hardware components. In order to process the graphics rendering instructions, CPU 110 may issue one or more rendering commands to GPU 125 (e.g., through GPU driver 120) to cause GPU 125 to perform some or all of the rendering of the graphics data. In some examples, the graphics data to be rendered may include a list of graphics primitives (e.g., points, lines, triangles, quadrilaterals, etc.).

The GPU program stored in system memory 140 may invoke or otherwise include one or more functions provided by GPU driver 120. CPU 110 generally executes the program in which the GPU program is embedded and, upon encountering the GPU program, passes the GPU program to GPU driver 120. CPU 110 executes GPU driver 120 in this context to process the GPU program. That is, for example, GPU driver 120 may process the GPU program by compiling the GPU program into object or machine code executable by GPU 125. This object code may be referred to as a locally-compiled GPU program. In some examples, a compiler associated with GPU driver 120 may operate in real-time or near-real-time to compile the GPU program during the execution of the program in which the GPU program is embedded. For example, the compiler may generally represent a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 110 and GPU 125).

In the example of FIG. 1, the compiler may receive the GPU program from CPU 110 when executing HL code that includes the GPU program. That is, a software application being executed by CPU 110 may invoke GPU driver 120 (e.g., via a graphics API) to issue one or more commands to GPU 125 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 125 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex, and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 120 may formulate one or more commands that specify one or more operations for GPU 125 to perform in order to render the primitive. When GPU 125 receives a command from CPU 110, it may decode the command and configure one or more processing elements to perform the specified operation and may output the rendered data to display buffer 135.

GPU 125 generally receives the locally-compiled GPU program, and then, in some instances, GPU 125 renders one or more images and outputs the rendered images to display buffer 135. For example, GPU 125 may generate a number of primitives to be displayed at display 145. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 125 for display as an image (or frame in the context of video data) via display 145. GPU 125 may transform primitives and other attributes (e.g., that define a color, texture, lighting, camera configuration, or other aspect) of the primitives into a so-called “world space” by applying one or more model transforms (which may also be specified in the state data). Once transformed, GPU 125 may apply a view transform for the active camera (which again may also be specified in the state data defining the camera) to transform the coordinates of the primitives and lights into the camera or eye space. GPU 125 may also perform vertex shading to render the appearance of the primitives in view of any active lights. GPU 125 may perform vertex shading in one or more of the above model, world, or view space.

Once the primitives are shaded, GPU 125 may perform projections to project the image into a canonical view volume. After transforming the model from the eye space to the canonical view volume, GPU 125 may perform clipping to remove any primitives that do not at least partially reside within the canonical view volume. That is, GPU 125 may remove any primitives that are not within the frame of the camera. GPU 125 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 125 may then rasterize the primitives. Generally, rasterization may refer to the task of taking an image described in a vector graphics format and converting it to a raster image (e.g., a pixelated image) for output on a video display or for storage in a bitmap file format.

In some examples, GPU 125 may implement tile-based rendering to render an image. For example, GPU 125 may implement a tile-based architecture that renders an image or rendering target by breaking the image into multiple portions, referred to as tiles or bins. The bins may be sized based on the size of GPU memory 130 (e.g., which may alternatively be referred to herein as GMEM or a cache). When implementing tile-based rendering, GPU 125 may perform a binning pass and one or more rendering passes. For example, with respect to the binning pass, GPU 125 may process an entire image and sort rasterized primitives into bins. GPU 125 may also generate one or more visibility streams during the binning pass, which visibility streams may be separated according to bin. For example, each bin may be assigned a corresponding portion of the visibility stream for the image. GPU driver 120 may access the visibility stream and generate command streams for rendering each bin. In aspects of the following, a binning pass may alternatively be referred to as a visibility stream operation.

With respect to each rendering pass, GPU 125 may perform a load operation, a rendering operation, and/or a store operation. During the load operation, GPU 125 may initialize GPU memory 130 for a new bin to be rendered. During the rendering operation, GPU 125 may render the bin and store the rendered bin to GPU memory 130. That is, GPU 125 may perform pixel shading (e.g., using shading processor 160) and other operations to determine pixel values for each pixel of the tile and write the pixel values to GPU memory 130. During the store operation, GPU 125 may transfer the finished pixel values of the bin from GPU memory 130 to display buffer 135 (or system memory 140). After GPU 125 has rendered all of the bins associated with a frame (e.g., or a given rendering target) in this way, display buffer 135 may output the finished image to display 145. In some cases, at least some of the bins may be rendered directly on system memory 140 (e.g., before being output to display buffer 135). That is, rather than being loaded from system memory 140 to the GMEM where the GPU 125 can quickly access and operate on the data before storing it to display buffer 135 or back to system memory 140, some bins may be operated on (e.g., by GPU 125) directly in system memory 140. In some such cases, the time (e.g., or processing power) saved by removing the load and store operations may outweigh the time lost by directly rendering in system memory 140 (e.g., rather than in a GMEM). In some cases, one or more procedures, such as filtering procedures, may include work load balancing between multiple processors of GPU 125 (e.g., texture processor 155 and shading processor 160).

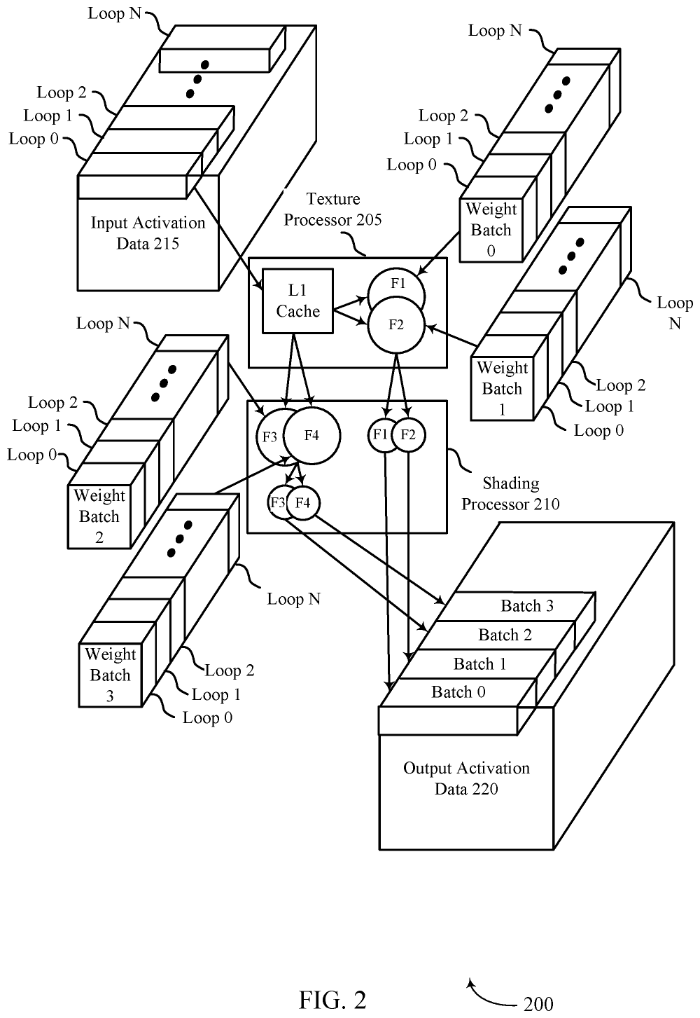

FIG. 2 illustrates an example of a filtering process 200 that supports resource based workload allocation for machine learning workloads in accordance with aspects of the present disclosure. In some examples, filtering process 200 may implement aspects of 100.

As described with respect to FIG. 1, a GPU may include a texture processor 205 and a shading processor 210. The GPU may perform one or more actions utilizing machine learning work loads (e.g., convolution neural network (CNN), matrix multiplication, etc.). Performance of machine learning procedures may be bounded by a rate of data loading (e.g., loading input activation data 215) and ALU availability and utilization. That is, if available ALU units are not utilized in an efficient way, then GPU performance may be degraded or may be inefficient. Similarly, if data loading can be performed more efficiently (e.g., loaded less often) then GPU processing may be more efficient. The GPU may improve process flow by balancing work loads to decrease the frequency of data loading and improve use of available ALUs (e.g., at both texture processor 205 and shading processor 210).

Texture processor 205 may include an L1 cache, which may fetch and load input activation data 215. Texture processor 205 may, using the L1 cache, operate as a data fetch engine for small chunks of data (e.g., input activation data included in loop 0).

The L1 cache may load the portion of input activation data 215 into the L1 cache, and may store the section of input activation data 215. The GPU may identify ALUs in texture processor 205 and ALUs in shading processor 210 for workload balancing. For instance, the GPU may determine a total number of ALUs available in both the texture processor 205 and shading processor 210. The GPU may also determine a ratio between available ALUs in the texture processor 205 and the shading processor 210.

The GPU may balance a workload between the texture processor 205 and the shading processor 210 by allocating weight batches to be used to perform filtering procedures (e.g., F1, F2, F3, and F4) on the input activation data 215 stored in the L1 cache of texture processor 205.

Filtering procedures may include one or more multiply and accumulate processes. Multiply and accumulate processes may include multiplying weight batches with input activation data 215, and accumulating resulting values. A first loop or iteration of the iterative machine learning procedure at the GPU may include loading loop 0 of the input activation data 215 into the L1 cache of texture processor 205. Upon determining the ratio of ALUs available at texture processor 205 and shading processor 210, respectively (e.g., a 1:1 ratio with available ALUs sufficient for two weight batches per processor), the GPU may initiate filtering procedures (e.g., F1, F2, F3, and F4). In some examples, the filtering procedures may include multiply and accumulate (e.g., MAC) processes. In such examples, the GPU may multiply loop 0 of weight batch 0 with the input activation data 215 in a first filtering procedure (e.g., F1). Without having to reload the input activation data 215 into texture processor 205, the GPU may multiply loop 0 of weight batch 1 with the input activation data 215 (e.g., F2). The GPU may complete the filtering procedures F1 and F2 (e.g., in shading processor 210). Texture processor 205 may complete F1 and F2, and send the result to shading processor 210, or may complete a portion of F1 and F2 via texture processor 205 and complete F1 and F2 in shading processor 210 (e.g., may perform the multiply aspect of the MAC process with texture processor 205 and part or all of the accumulate aspect of the MAC process with shading processor 210). Upon completing F1 and F2, shading processor 210 may generate output activation data 220. For instance, shading processor 210 may generate batch 0 and batch 1 of output activation data 220, corresponding to the loop 0 portion of input activation data 215 loaded into the L1 cache of texture processor 205.

Without having to reload the loop 0 portion of input activation data 215 into the L1 cache, shading processor 210 may perform additional filtering procedures (e.g., F3 and F4). For instance, texture processor 205 may provide the input activation data 215 to shading processor 210. the GPU may multiply loop 0 of weight batch 2 and loop 0 of weight batch 3 with the loop 0 portion of input activation data 215 using the shading processor 210. The GPU may perform an accumulate aspect of a MAC process using shading processor 210, and may generate batch 2 and batch 3, respectively, of output activation data 220. F1 and F2, and F3 and F4, may be performed in parallel by texture processor 205 and shading processor 210, respectively. In such cases, multiple filtering operations (e.g., F1, F2, F3, and F4), including multiplying the input activation data 215 by multiple weight batches (e.g., weight batches 0, 1, 2, and 3) may be performed without having to reload the loop 0 portion of input activation data 215. Further, the parallel filtering procedures may improve the efficiency of available ALU resource usage, resulting in improved system efficiency, use of computational resources, and increased speed for tasks at the GPU. The iterative process may include multiple loops.

Each loop iteration may be defined as a number of multiply and accumulate operations (e.g., filtering operations) which may be performed in any order. For example, the multiply and accumulate aspects of the MAC process may be performed in any order (e.g., first multiplying a weight batch with stored input activation data 215, then accumulating the result with previous results, or first accumulating the weight batch and the input activation data 215, then performing the multiplication). Increased size of each loop iteration may improve level one procedure efficiencies, and the size of each loop iteration may be based at least partially on the size of the L1 cache of texture processor 205. That is, the amount of input activation data 215 that can be stored in the L1 cache may be limited by the size of the L1 cache. However, overall system efficiency may be improved by increasing the number of weight batches that can be applied to the stored data, without having to reload the data, or before loading a next portion of the data. A non-limiting illustrative example of a loop iteration may include generating an output activation (oAct) positioned at a point (x, y) for a weight batch (b), which may include the following commands:

oAct (x, y, b) = 0;
for each wz in filterDepth

for each wy in filterHeight

for each wx in filterWidth

oAct (x, y, b) += iAct ({x,

y,0}−filterCenter.XY0+{wx,wy,wz}) * Weight Batch(wx,wy,wz,b);

where the multiply and accumulate steps may be done in any order.

In some examples, the GPU may determine a number of fibers for a particular sub-group (e.g., a number of portions of input activation data 215 to which the weight batches are to be applied). Each sub-group may consist of a number of fibers. Each fiber may perform one or more functions in parallel with other fibers in the sub-group. In this flow, each fiber for a given sub-group is using a different portion of input activation data but the same allocations of the weight batches. In some cases, the size of a loop iteration may consider the number of fibers in each sub-group to accommodate the input activation data 215 usage for each fiber.

In some examples, the workload between texture processor 205 and shading processor 210 may be synchronized. That is, the GPU may perform the filtering procedures (e.g., F1, F2, F3, and F4) in parallel at texture processor 205 and shading processor 210. The GPU may not load any additional input activation data 215 to the L1 cache until the GPU has completed all of the filtering procedures using all available ALU resources and has generated output activation data 220 corresponding to the portion of input activation data 215. Such synchronization and improved efficiency may benefit from determining the total available AULs at both texture processor 205 and shading processor 210, and the ratio of available AULs at texture processor 205 and shading processor 210. For instance, the GPU may determine that the ratio of available texture processor 205 ALUs and available shading processor 210 AULs is 1:1. In such examples, the GPU could apply one weight batch (e.g., weight batch 0) to the input activation data 215 using the texture processor 205 and one weight batch (e.g., weight batch 2) to the input activation data 215 using shading processor 210). However, only two filtering procedures could be simultaneously completed in parallel in such examples. To improve system efficiency, the GPU may also determine the total number of available ALUs at both processors. Thus, instead of only applying one weight batch at each processor, the GPU may apply, for example, two weight batches at each processor, performing four filtering procedures instead of two. Although the workload distribution ratio is the same in both examples, using all available ALUs while respecting the determined available ALU ratio may result in less data fetching by the L1 cache, and increased processing speed by the GPU.

In some examples, upon generating output activation data 220 (e.g., batch 0, batch 1, batch 2, and batch 3 of output activation data 220), the GPU may perform multiple iterations of the process. For instance, the L1 cache may fetch and load a loop 1 portion of the input activation data 215. The GPU may apply loop 1 of weight batch 0 to the stored input activation data 215, performing a filtering procedure (e.g., F1) and may apply loop 1 of weight batch 1 to the stored input activation data 215, performing a filtering procedure (e.g., F2) using texture processor 205. Similarly, the GPU may perform F3 and F4 by applying the loop 1 of weight batch 2 and weight batch 3. Upon completing the filtering procedures, shading processor 210 may generate additional portions of output activation data 220. Texture processor 205 and shading processor 210 may continue to perform filtering on portions of input activation data 215 (e.g., may load loop 2 through loop n of input activation data 215 into the L1 cache and multiply the input activation data 215 by loop 2 through loop N of weight batches 0-3, respectively, in parallel using texture processor 205 and shading processor 210), until all of input activation data 215 has been filtered to generate complete output activation data 220.

In some examples, the output activation data 220 may be directed to a particular use case. For instance, input activation data 215 may include one or more images (e.g., a 2D image, a 3D image, etc.). Each weight batch may be multiplied by a portion of input activation data 215. For instance, each weight batch may be applied to each pixel of the image, and may be used to identify an aspect of the image. A weight batch may be applied to determine whether a portion of input activation data 215 includes a diagonal line, a circle, a square, a rectangle, or the like. Upon applying the different weight batches to the input activation data 215, the GPU may generate output activation data 220. The output activation data 220 may represent the determination of whether the aspects filtered for are present in input activation data 215. That is, output activation data 220 may be a representation of whether input activation data 215 includes one or more diagonal lines, squares, circles, rectangles, etc. Output activation data 220 may be used, at a next level (e.g., a level 2 of a machine learning process) as input activation data. For instance, if output activation data 220 includes an indication of whether certain shapes are included in input activation data 215, then a next level of a machine learning process may include face recognition, image recognition, matching, rendering, or the like, based on the determined shapes, lines, etc. in input activation data 215 (as represented by output activation data 220. In some examples, the second level of the machine learning procedure may implement some or all aspects of the workload balancing procedure described with respect to FIG. 2.

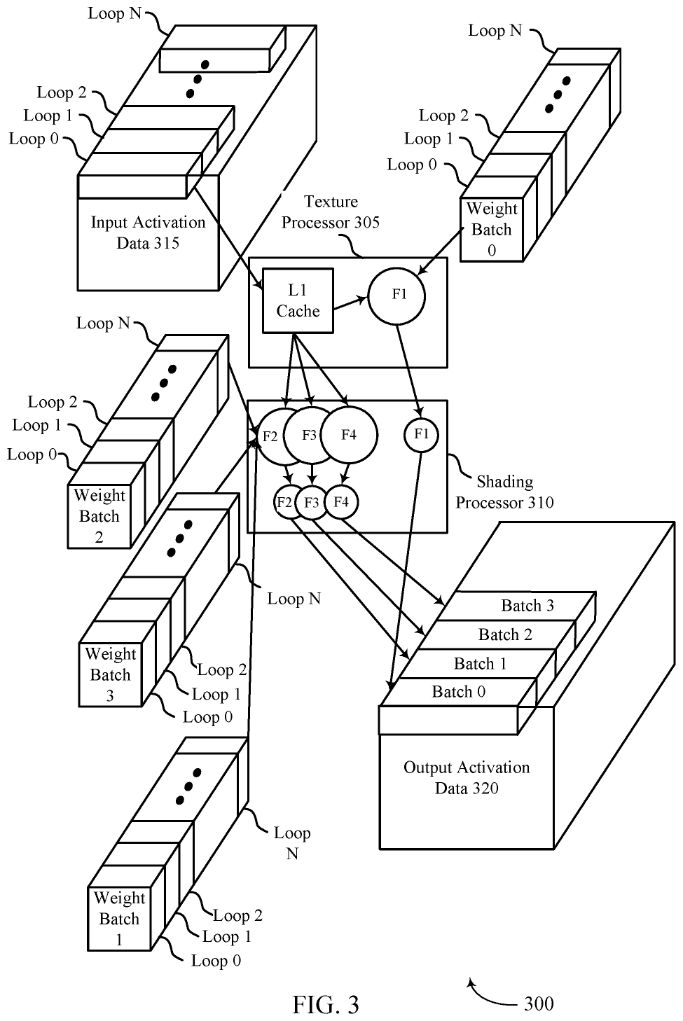

The described techniques may, as discussed with respect to FIG. 2 and FIG. 3, increase the size of portions of input activation data 215 that can be filtered in parallel. The size of the input activation data 215 loaded into the L1 cache of texture processor 205 may be limited by the size of the L1 cache and the number of fibers associated with each sub-group of the iterative machine learning procedure. The described techniques may further balance a workload between available ALU resources, including ALU resources of the texture processor 205 and the shading processor 210 (instead of relying solely on the ALU resources available in the shading processor 210). By utilizing both the texture processor 205 and the shading processor 210, a GPU may increase the total number of weight batches uses per loop iteration. The total number of weight batches used for filtering the input activation data 215 may be limited by an accumulation register space available inside the SP and possible level two weight batch caching constraints. That is, filtering procedures using weight batches may include one or more multiply and accumulate processes. The amount of weight batches that can be applied during a single loop iteration may be limited the space available in the shading processor 210 for iteratively accumulating multiplied values.

The described techniques may result in decreased execution time and decreased level two requests. For instance, in a non-limiting illustrative example of the iterative machine learning process, a 3×3×80 input activation data layer may be filtered with 192 batches of 3×3×80 filters. A baseline process (e.g., using only the shading processor for filtering input activation data) may take 1,331 μs. The performance uplift and improved efficiencies of the described techniques in such an example may result in a total time of 747 μs. L2 requests for the baseline process may be equal to about 131 megabytes (MB). The L2 request benefits of the described techniques may result in only 54 MB.

In some examples, the GPU may perform the described techniques via one or more commands. For instance, for a 3×3 filter, the GPU may synchronize data loading between the texture processor 205 and shading processor 210, with a ratio of 1:2 (e.g., one weight batch using texture processor 205 and two weight batches using shading processor 210). In such examples, the GPU may use a gathering command to load input activation data 215 into the L1 cache in the texture processor 205, and to pass the input activation data to shading processor 210. A high order filtering (HOF) command may initiate the filtering, and an accumulate HOF results for a weight batch command may complete the multiply and accumulate procedure.

FIG. 3 illustrates an example of a filtering process 300 that supports resource based workload allocation for machine learning workloads in accordance with aspects of the present disclosure. In some examples, filtering process 300 may implement aspects of device 100.

In some examples, as described with respect to FIGS. 1 and 2, a GPU may include a texture processor 305 and a shading processor 310. The GPU may perform one or more actions utilizing machine learning workloads (e.g., convolution neural network (CNN), matrix multiplication, etc.). Performance of machine learning procedures may be bounded by a rate of data loading (e.g., loading input activation data 315) and ALU availability and utilization. Texture processor 305 may include an L1 cache, which may load input activation data 315. Texture processor 305 may, with use of the L1 cache, operate as a data fetch engine for small chunks of data (e.g., loop 0 portion of input activation data).

Upon loading the portion of input activation data 315 (e.g., loop 0 portion of input activation data 315) into the L1 cache, the L1 cache may store the section of input activation data 315. The GPU may identify ALUs in texture processor 305 and ALUs in shading processor 310. For instance, the GPU may determine a total number of ALUs available between both the texture processor 305 and shading processor 310. The GPU may also determine a ratio between the texture processor 305 and the shading processor 310.

The GPU may balance a work load between the texture processor 305 and the shading processor 310. The GPU may determine the available ALUs in both texture processor 305 and shading processor 310 and may allocate weight batches to be used to perform filtering options (e.g., F1, F2, F3, and F4) on the input activation data 315 stored in the L1 cache of texture processor 305. For instance, the GPU may allocate weight batches between texture processor 305 and shading processor 310 at a ratio of 1:3 (e.g., may apply weight batch 0 to the input activation data 315 using the texture processor 305 and may apply weight batch 2, weight batch 3, and weight batch 4 to the input activation data 315 every loop over the iterative machine learning process).

Filtering procedures may include one or more multiply and accumulate processes. Multiply and accumulate processes may include multiplying weight batches with input activation data 315. A first loop or iteration of the iterative machine learning procedure at the GPU may include loading loop 0 of the input activation data 315 into the L1 cache of texture processor 205. Upon determining the ratio of ALUs available at texture processor 305 and shading processor 210, respectively (e.g., a 1:3 ratio with available ALUs sufficient for one weight batch for texture processor 305 and three weight batches for shading processor 310), the GPU may initiate filtering procedures (e.g., F1, F2, F3, and F4). In some examples, the filtering procedures may include multiply and accumulate (e.g., MAC) processes. In such examples, the GPU may multiply loop 0 of weight batch 0 with the input activation data 315 in a first filtering procedure (e.g., F1) using texture processor 305. The GPU may complete the filtering procedure F1 (e.g., in shading processor 310), and may generate batch 0 of output activation data 320. Without having to reload the input activation data 315 into texture processor 305, the GPU may multiply loop 0 of weight batch 1 with the input activation data 315 (e.g., F2) using shading processor 310, loop 0 of weight batch 2 with the input activation data 315 (e.g., F3) using shading processor 310, and loop 0 of weight batch 3 with the input activation data 315 (e.g., F4) using shading processor 310. Upon completing F2, F3, and F4, shading processor 310 may generate batch 1, batch 2, and batch 3 of output activation data 320. Output activation data 320 may be used as input activation data for a subsequent level of the iterative machine learning process.

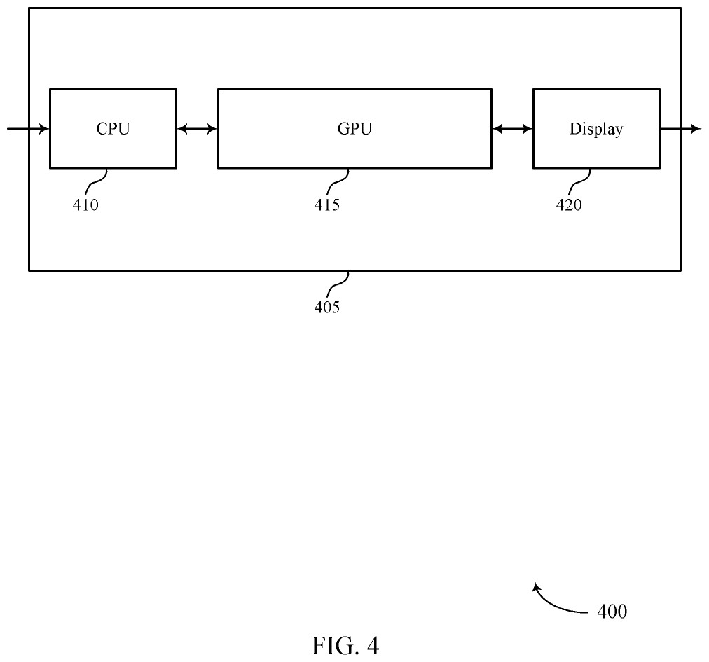

FIG. 4 shows a block diagram 400 of a device 405 that supports resource based workload allocation for machine learning workloads in accordance with aspects of the present disclosure. The device 405 may be an example of aspects of a device as described herein. The device 405 may include a central processing unit (CPU) 410, a GPU 415, and a display 420. The device 405 may also include one or more processors. Each of these components may be in communication with one another (e.g., via one or more buses).

The CPU 410 may receive information such as packets, user data, or control information associated with various information channels (e.g., control channels, data channels, and information related to efficient dependency detection for concurrent binning GPU workloads, etc.). Information may be passed on to other components of the device Error! Reference source not found.05. The CPU 410 may utilize a single antenna or a set of antennas.

The GPU 415 may identify, based on a size of a level one cache (e.g., a level one cache of a texture processor), a portion of input activation data for an iterative machine-learning process, process the portion of input activation data based on the first set of one or more weight batches and the second set of one or more weight batches using the texture processor and the shading processor in parallel, load the portion of input activation data into the level one cache of the texture processor based on the identifying, and allocate, based on a texture processor to shading processor arithmetic logic unit (ALU) resource ratio, a first set of one or more weight batches associated with the loaded portion of input activation data to the texture processor and a second set of one or more weight batches associated with the loaded portion of input activation data to the shading processor. The GPU 415 may be an example of aspects of the GPU 710 described herein.

The GPU 415, or its sub-components, may be implemented in hardware, code (e.g., software or firmware) executed by a processor, or any combination thereof. If implemented in code executed by a processor, the functions of the GPU 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The GPU 415, or its sub-components, may be physically located at various positions, including being distributed such that portions of functions are implemented at different physical locations by one or more physical components. In some examples, the GPU 415, or its sub-components, may be a separate and distinct component in accordance with various aspects of the present disclosure. In some examples, the GPU 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The display 420 may provide images to a user as generated by other components of the device 405. In some examples, the display 420 may be collocated with other aspects of the device 405.

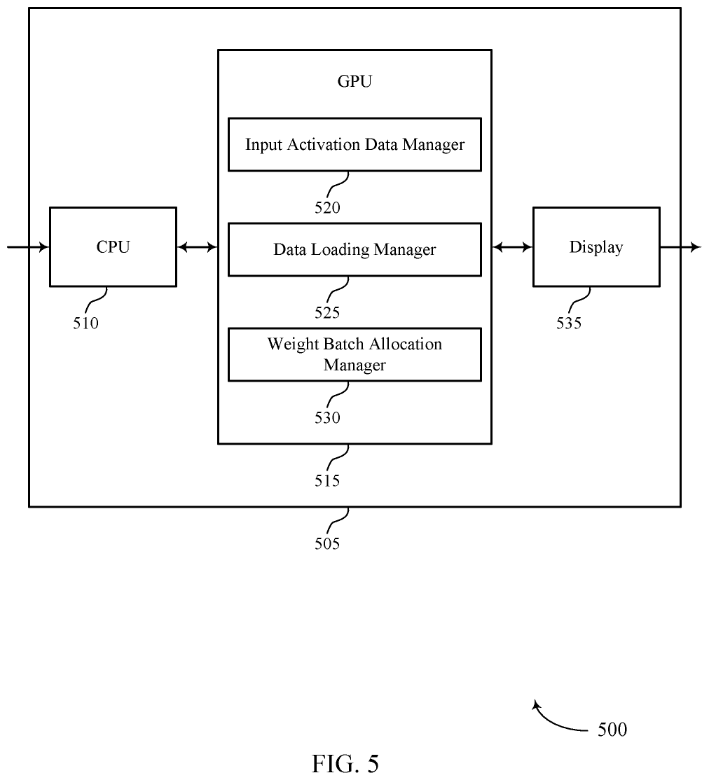

FIG. 5 shows a block diagram 500 of a device 505 that supports resource based workload allocation for machine learning workloads in accordance with aspects of the present disclosure. The device 505 may be an example of aspects of a device 405 as described herein. The device 505 may include a CPU 510, a GPU 515, and a display 535. The device 505 may also include a processor. Each of these components may be in communication with one another (e.g., via one or more buses).

The CPU 510 may receive information such as packets, user data, or control information associated with various information channels (e.g., control channels, data channels, and information related to efficient dependency detection for concurrent binning GPU workloads, etc.). Information may be passed on to other components of the device 505.

The GPU 515 may be an example of aspects of the GPU 415 as described herein. The GPU 515 may include an input activation data manager 520, a data loading manager 525, and a weight batch allocation manager 530. The GPU 515 may be an example of aspects of the GPU 710 described herein.

The input activation data manager 520 may identify, based on a size of a level one cache of a texture processor, a portion of input activation data for an iterative machine-learning process and process the portion of input activation data based on the first set of one or more weight batches and the second set of one or more weight batches using the texture processor and the shading processor in parallel.

The data loading manager 525 may load the portion of input activation data into the level one cache of the texture processor based on the identifying.

The weight batch allocation manager 530 may allocate, based on a texture processor to shading processor arithmetic logic unit (ALU) resource ratio, a first set of one or more weight batches associated with the loaded portion of input activation data to the texture processor and a second set of one or more weight batches associated with the loaded portion of input activation data to the shading processor.

The display 535 may show one or more images to a user as generated by one or more components of device 505.

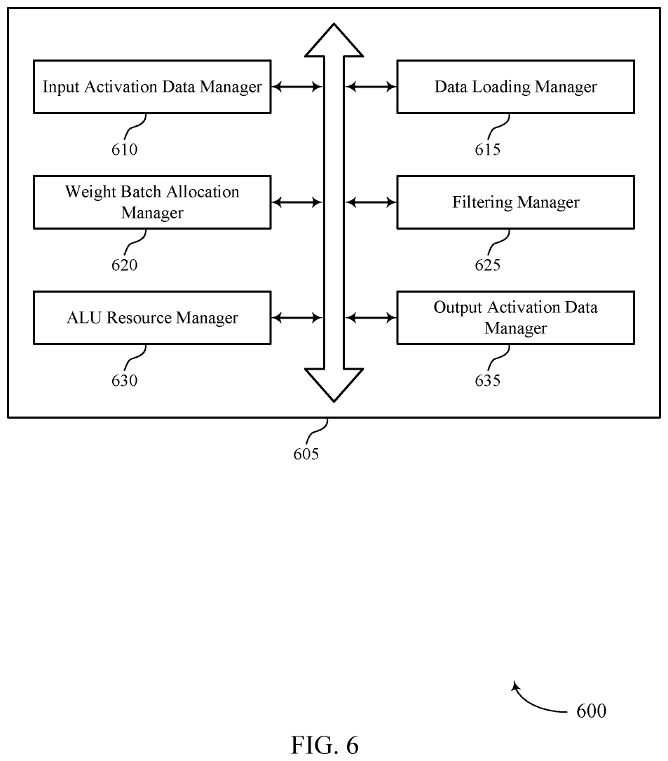

FIG. 6 shows a block diagram 600 of a GPU 605 that supports resource based workload allocation for machine learning workloads in accordance with aspects of the present disclosure. The GPU 605 may be an example of aspects of a GPU 415, a GPU 515, or a GPU 710 described herein. The GPU 605 may include an input activation data manager 610, a data loading manager 615, a weight batch allocation manager 620, a filtering manager 625, an ALU resource manager 630, and an output activation data manager 635. Each of these modules may communicate, directly or indirectly, with one another (e.g., via one or more buses).

The input activation data manager 610 may identify, based on a size of a level one cache of a texture processor, a portion of input activation data for an iterative machine-learning process. In some examples, the input activation data manager 610 may process the portion of input activation data based on the first set of one or more weight batches and the second set of one or more weight batches using the texture processor and the shading processor in parallel. In some examples, the input activation data manager 610 may identify, based on having generated the portion of output activation data and based on the size of the level one cache of the texture processor, a second portion of input activation data for the iterative machine-learning process. In some examples, the input activation data manager 610 may perform one or more iterations of the iterative machine-learning process until all of the input activation data has been processed. In some examples, the input activation data manager 610 may determine a number of fibers associated with a first iteration of the iterative machine-learning process, where identifying the portion of input activation data for the iterative machine-learning process is based on the number of fibers.

The data loading manager 615 may load the portion of input activation data into the level one cache of the texture processor based on the identifying.

The weight batch allocation manager 620 may allocate, based on a texture processor to shading processor arithmetic logic unit (ALU) resource ratio, a first set of one or more weight batches associated with the loaded portion of input activation data to the texture processor and a second set of one or more weight batches associated with the loaded portion of input activation data to the shading processor. In some examples, the weight batch allocation manager 620 may identify, by the texture processor, the first set of one or more weight batches from a system memory. In some examples, the weight batch allocation manager 620 may identify, by the shading processor, the second set of one or more weight batches from the system memory.

In some examples, the weight batch allocation manager 620 may identify, by the texture processor, the first set of one or more weight batches and the second set of one or more weight batches from a system memory. In some examples, the weight batch allocation manager 620 may send, by the texture processor, the second set of one or more weight batches to the shading processor.

The filtering manager 625 may perform one or more filtering operations on the portion of input activation data, using the first set of one or more weight batches and the second set of one or more weight batches. In some cases, each of the one or more filtering operations further includes a multiply-accumulate operation, where a multiplication aspect of the multiply-accumulate operation includes multiplying a first batch of the first set of one or more weight batches or the second set of one or more weight batches with the portion of input activation data.

The ALU resource manager 630 may determine a number of available ALU resources for the texture processor. In some examples, the ALU resource manager 630 may determine a number of available ALU resources for the shading processor. In some examples, the ALU resource manager 630 may determine a total number of available ALU resources including the number of available ALU resources for the texture processor and the number of available ALU resources for the shading processor.

In some examples, the ALU resource manager 630 may identify the texture processor to shading processor ALU resource ratio based on the number of available ALU resources for the texture processor and the number of available ALU resources for the shading processor. In some examples, the ALU resource manager 630 may identify an accumulation register space available within the shading processor, where determining the total number of available ALU resources is based on the accumulation register space. In some examples, the ALU resource manager 630 may determine a level two weight batch caching constraint for a second level of the iterative machine-learning process, where determining the total number of available ALU resources is based on the level two weight batch caching constraint.

The output activation data manager 635 may generate a portion of output activation data based on the processing the portion of input activation data.

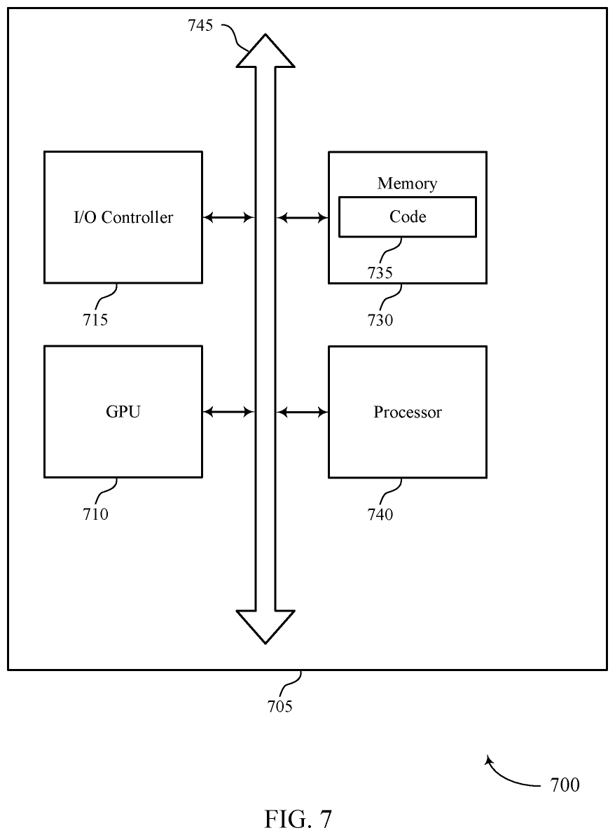

FIG. 7 shows a diagram of a system 700 including a device 705 that supports resource based workload allocation for machine learning workloads in accordance with aspects of the present disclosure. The device 705 may be an example of or include the components of device 405, device 505, as described herein. The device 705 may include components for bi-directional voice and data communications including components for transmitting and receiving communications, including a GPU 710, an I/O controller 715, a memory 730, and a processor 740. These components may be in electronic communication via one or more buses (e.g., bus 745).

The GPU 710 may identify, based on a size of a level one cache of a texture processor, a portion of input activation data for an iterative machine-learning process, process the portion of input activation data based on the first set of one or more weight batches and the second set of one or more weight batches using the texture processor and the shading processor in parallel, load the portion of input activation data into the level one cache of the texture processor based on the identifying, and allocate, based on a texture processor to shading processor arithmetic logic unit (ALU) resource ratio, a first set of one or more weight batches associated with the loaded portion of input activation data to the texture processor and a second set of one or more weight batches associated with the loaded portion of input activation data to the shading processor.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting resource based workload allocation for machine learning workloads).

The code 735 may include instructions to implement aspects of the present disclosure, including instructions to support workload balancing for machine learning. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

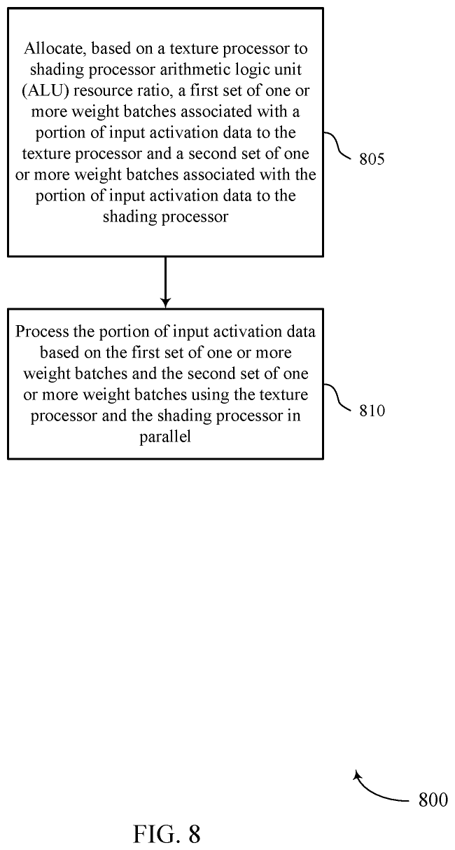

FIG. 8 shows a flowchart illustrating a method 800 that supports resource based workload allocation for machine learning workloads in accordance with aspects of the present disclosure. The operations of method 800 may be implemented by a device or its components as described herein. For example, the operations of method 800 may be performed by a GPU as described with reference to FIGS. 4 through 7. In some examples, a device may execute a set of instructions to control the functional elements of the device to perform the functions described below. Additionally, or alternatively, a device may perform aspects of the functions described below using special-purpose hardware.

At 805, the device may allocate, based on a texture processor to shading processor arithmetic logic unit (ALU) resource ratio, a first set of one or more weight batches associated with a portion of input activation data to the texture processor and a second set of one or more weight batches associated with the portion of input activation data to the shading processor. The operations of 815 may be performed according to the methods described herein. In some examples, aspects of the operations of 815 may be performed by a weight batch allocation manager as described with reference to FIGS. 4 through 7.

At 810, the device may process the portion of input activation data based on the first set of one or more weight batches and the second set of one or more weight batches using the texture processor and the shading processor in parallel. The operations of 820 may be performed according to the methods described herein. In some examples, aspects of the operations of 820 may be performed by an input activation data manager as described with reference to FIGS. 4 through 7.

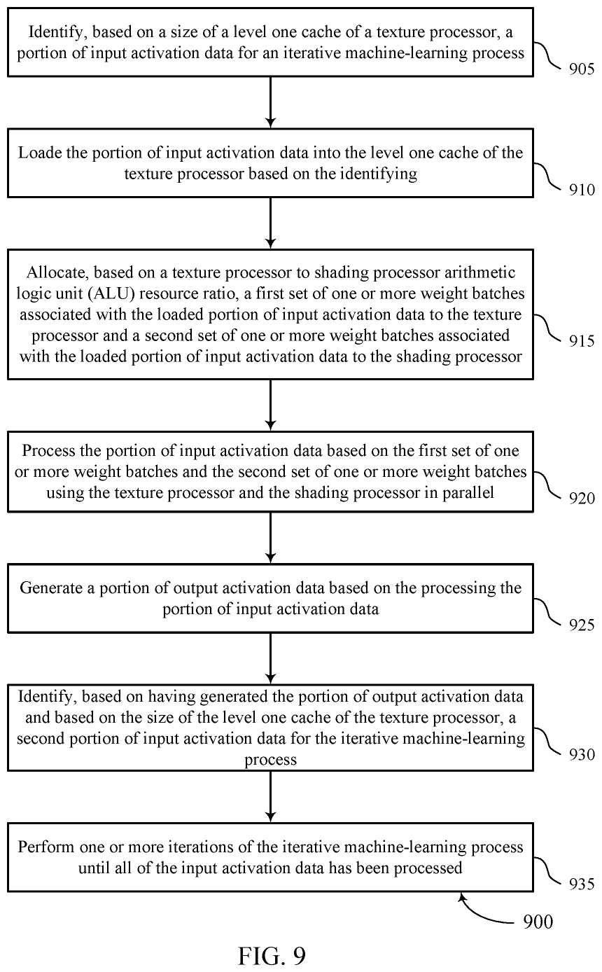

FIG. 9 shows a flowchart illustrating a method 900 that supports resource based workload allocation for machine learning workloads in accordance with aspects of the present disclosure. The operations of method 900 may be implemented by a device and its components as described herein. For example, the operations of method 900 may be performed by a GPU as described with reference to FIGS. 4 through 7. In some examples, a device may execute a set of instructions to control the functional elements of the device to perform the functions described below. Additionally, or alternatively, a device may perform aspects of the functions described below using special-purpose hardware.

At 905, the device may identify, based on a size of a level one cache of a texture processor, a portion of input activation data for an iterative machine-learning process. The operations of 905 may be performed according to the methods described herein. In some examples, aspects of the operations of 905 may be performed by an input activation data manager as described with reference to FIGS. 4 through 7.

At 910, the device may load the portion of input activation data into the level one cache of the texture processor based on the identifying. The operations of 910 may be performed according to the methods described herein. In some examples, aspects of the operations of 910 may be performed by a data loading manager as described with reference to FIGS. 4 through 7.

At 915, the device may allocate, based on a texture processor to shading processor arithmetic logic unit (ALU) resource ratio, a first set of one or more weight batches associated with the loaded portion of input activation data to the texture processor and a second set of one or more weight batches associated with the loaded portion of input activation data to the shading processor. The operations of 915 may be performed according to the methods described herein. In some examples, aspects of the operations of 915 may be performed by a weight batch allocation manager as described with reference to FIGS. 4 through 7.

At 920, the device may process the portion of input activation data based on the first set of one or more weight batches and the second set of one or more weight batches using the texture processor and the shading processor in parallel. The operations of 920 may be performed according to the methods described herein. In some examples, aspects of the operations of 920 may be performed by an input activation data manager as described with reference to FIGS. 4 through 7.

At 925, the device may generate a portion of output activation data based on the processing the portion of input activation data. The operations of 925 may be performed according to the methods described herein. In some examples, aspects of the operations of 925 may be performed by an output activation data manager as described with reference to FIGS. 4 through 7.

At 930, the device may identify, based on having generated the portion of output activation data and based on the size of the level one cache of the texture processor, a second portion of input activation data for the iterative machine-learning process. The operations of 930 may be performed according to the methods described herein. In some examples, aspects of the operations of 930 may be performed by an input activation data manager as described with reference to FIGS. 4 through 7.

At 935, the device may perform one or more iterations of the iterative machine-learning process until all of the input activation data has been processed. The operations of 935 may be performed according to the methods described herein. In some examples, aspects of the operations of 935 may be performed by an input activation data manager as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc.

UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for workload balancing for machine learning, comprising:
allocating, based at least in part on a texture processor to shading processor arithmetic logic unit (ALU) resource ratio, a first set of one or more weight batches associated with a portion of input activation data to the texture processor and a second set of one or more weight batches associated with the portion of input activation data to the shading processor; and
processing the portion of input activation data based at least in part on the first set of one or more weight batches and the second set of one or more weight batches using the texture processor and the shading processor in parallel.

2. The method of claim 1, further comprising:
identifying, based at least in part on a size of a level one cache of the texture processor, the portion of input activation data for an iterative machine-learning process; and
loading the portion of input activation data into the level one cache of the texture processor based at least in part on the identifying.

3. The method of claim 1, wherein processing the portion of input activation data further comprises:
performing one or more filtering operations on the portion of input activation data, using the first set of one or more weight batches and the second set of one or more weight batches.

4. The method of claim 3, wherein each of the one or more filtering operations further comprises a multiply-accumulate operation, wherein a multiplication aspect of the multiply-accumulate operation comprises multiplying a first batch of the first set of one or more weight batches or the second set of one or more weight batches with the portion of input activation data.

5. The method of claim 1, further comprising:
determining a number of available ALU resources for the texture processor;
determining a number of available ALU resources for the shading processor;
determining a total number of available ALU resources comprising the number of available ALU resources for the texture processor and the number of available ALU resources for the shading processor; and
identifying the texture processor to shading processor ALU resource ratio based at least in part on the number of available ALU resources for the texture processor and the number of available ALU resources for the shading processor.

6. The method of claim 5, further comprising:
identifying an accumulation register space available within the shading processor, wherein determining the total number of available ALU resources is based at least in part on the accumulation register space.

7. The method of claim 5, further comprising:
determining a level two weight batch caching constraint for a second level of an iterative machine-learning process, wherein determining the total number of available ALU resources is based at least in part on the level two weight batch caching constraint.

8. The method of claim 1, further comprising:
generating a portion of output activation data based at least in part on the processing the portion of input activation data; and
identifying, based at least in part on having generated the portion of output activation data and based at least in part on the size of a level one cache of the texture processor, a second portion of input activation data for an iterative machine-learning process.

9. The method of claim 8, further comprising:
performing one or more iterations of the iterative machine-learning process until all of the input activation data has been processed.

10. The method of claim 1, further comprising:
identifying, by the texture processor, the first set of one or more weight batches from a system memory; and
identifying, by the shading processor, the second set of one or more weight batches from the system memory.

11. The method of claim 1, further comprising:
identifying, by the texture processor, the first set of one or more weight batches and the second set of one or more weight batches from a system memory; and
sending, by the texture processor, the second set of one or more weight batches to the shading processor.

12. The method of claim 1, further comprising:
determining a number of fibers associated with a first iteration of an iterative machine-learning process, wherein identifying the portion of input activation data for the iterative machine-learning process is based at least in part on the number of fibers.

13. An apparatus for workload balancing for machine learning, comprising:
a processor,
memory coupled with the processor; and
instructions stored in the memory and executable by the processor to cause the apparatus to:
allocate, based at least in part on a texture processor to shading processor arithmetic logic unit (ALU) resource ratio, a first set of one or more weight batches associated with a portion of input activation data to the texture processor and a second set of one or more weight batches associated with the portion of input activation data to the shading processor; and
process the portion of input activation data based at least in part on the first set of one or more weight batches and the second set of one or more weight batches using the texture processor and the shading processor in parallel.

14. The apparatus of claim 13, further comprising:
identify, based at least in part on a size of a level one cache of the texture processor, the portion of input activation data for an iterative machine-learning process: and
load the portion of input activation data into the level one cache of the texture processor based at least in part on the identifying.

15. The apparatus of claim 13, wherein the instructions to process the portion of input activation data further are executable by the processor to cause the apparatus to:
perform one or more filtering operations on the portion of input activation data, using the first set of one or more weight batches and the second set of one or more weight batches.

16. The apparatus of claim 15, wherein each of the one or more filtering operations further comprises a multiply-accumulate operation, wherein a multiplication aspect of the multiply-accumulate operation comprises multiplying a first batch of the first set of one or more weight batches or the second set of one or more weight batches with the portion of input activation data.

17. The apparatus of claim 13, wherein the instructions are further executable by the processor to cause the apparatus to:
determine a number of available ALU resources for the texture processor;
determine a number of available ALU resources for the shading processor;
determine a total number of available ALU resources comprising the number of available ALU resources for the texture processor and the number of available ALU resources for the shading processor; and
identify the texture processor to shading processor ALU resource ratio based at least in part on the number of available ALU resources for the texture processor and the number of available ALU resources for the shading processor.

18. The apparatus of claim 17, wherein the instructions are further executable by the processor to cause the apparatus to:
identify an accumulation register space available within the shading processor, wherein determining the total number of available ALU resources is based at least in part on the accumulation register space.

19. The apparatus of claim 17, wherein the instructions are further executable by the processor to cause the apparatus to:
determine a level two weight batch caching constraint for a second level of an iterative machine-learning process, wherein determining the total number of available ALU resources is based at least in part on the level two weight batch caching constraint.

20. An apparatus for workload balancing for machine learning, comprising:
means for allocating, based at least in part on a texture processor to shading processor arithmetic logic unit (ALU) resource ratio, a first set of one or more weight batches associated with a portion of input activation data to the texture processor and a second set of one or more weight batches associated with the portion of input activation data to the shading processor; and
means for processing the portion of input activation data based at least in part on the first set of one or more weight batches and the second set of one or more weight batches using the texture processor and the shading processor in parallel.
